(19) United States
(12) Patent Application Publication
(10) Pub. No.: US 2022/0099347 A1
(43) Pub. Date: Mar. 31, 2022

(54) INFORMATION PROCESSING APPARATUS, AIR-CONDITIONING APPARATUS, AND AIR-CONDITIONING SYSTEM

(71) Applicant: MITSUBISHI ELECTRIC CORPORATION, Tokyo (JP)

(72) Inventor: Yuki MOCHIZUKI, Tokyo (JP)

(21) Appl. No.: 17/421,547

(22) PCT Filed: Mar. 13, 2019
(86) PCT No.: PCT/JP2019/010176

§ 371 Date: Jul. 8, 2021

(51) Int. Cl. F25B 49/02; F25B 31/00; G06N 20/00

(52) U.S. Cl. CPC F25B 49/022; F25B 31/004; G06N 20/00; F25B 2700/171; F25B 2600/0253; F25B 2700/2104; F25B 2700/2106; F25B 2500/19

(57) ABSTRACT

An information processing apparatus obtains a heat load equation for calculating a heat load corresponding to a time at which a predetermined time period has elapsed from a current point in time using learning data concerning a heat load influencing factor of an air-conditioning apparatus, estimates, in a case where a compressor continues performing a low load operation, in which operation is performed at a standard operating frequency or less, for a predetermined time period or more, whether the heat load will become higher than the current point in time after the predetermined time period has elapsed using the heat load equation obtained, outputs, when estimating that the heat load will not become higher, an oil return command signal commanding that an operating frequency be increased to the compressor, and does not output, when estimating that the heat load will become higher, the oil return command signal to the compressor.

### TECHNICAL FIELD

The present disclosure relates to an information processing apparatus, an air-conditioning apparatus, and an air-conditioning system that estimate a heat load.

### BACKGROUND ART

Hitherto, an air-conditioning apparatus provided with a refrigerant circuit includes a compressor capable of changing an operation capacity such as an inverter to cope with changes in the heat load of an air-conditioning target, and controls the operating frequency of the compressor in accordance with the magnitude of a heat load. In an existing air-conditioning apparatus, the amount of refrigerant circulating in a refrigerant circuit decreases at the time of a low load operation, in which a compressor operates in a state where the compressor is set to have a low capacity, and thus refrigerating machine oil discharged from the compressor together with refrigerant tends to stay in the refrigerant circuit. As a result, the amount of refrigerating machine oil in the compressor decreases. When the amount of refrigerating machine oil inside the compressor decreases, the compressor may superheat and seizure of a movable portion may occur in the compressor.

Thus, when the compressor continues performing the low load operation for a long time period, the existing air-conditioning apparatus performs an oil return operation in which refrigerating machine oil is returned from the refrigerant circuit to the compressor by compulsorily making the compressor operate with a high capacity to increase the amount of circulation of refrigerant (for example, see Patent Literature 1). In a refrigeration apparatus disclosed in Patent Literature 1, while the amount of circulation of refrigerant is being increased, an expansion valve is made open to promote collection of refrigerating machine oil.

### CITATION LIST

### Patent Literature

Patent Literature 1: Japanese Unexamined Patent Application Publication No. 2002-349938

### SUMMARY OF INVENTION

### Technical Problem

In the refrigeration apparatus disclosed in Patent Literature 1, even in a case where the compressor will shift to a high load operation in the near future such as after a few minutes from the current point in time and the operating frequency of the compressor will increase, after the compressor has operated in a low load operation state for a long time period, the operating frequency of the compressor is increased.

Thus, if the compressor performs the oil return operation immediately before shifting to the high load operation, the power for the oil return operation performed immediately prior to the shifting is wasted.

The present disclosure is made to solve the problem as described above and provides an information processing apparatus, an air-conditioning apparatus, and an air-conditioning system that suppress the power consumption of a compressor and efficiently collect refrigerating machine oil from a refrigerant circuit.

### Solution to Problem

An information processing apparatus according to an embodiment of the present disclosure includes a heat load learning unit that obtains a heat load equation for calculating a heat load corresponding to a time at which a predetermined time period has elapsed from a current point in time using learning data concerning a heat load influencing factor of an air-conditioning apparatus including a compressor, an estimation unit that estimates, in a case where the compressor continues performing a low load operation, in which operation is performed at a standard operating frequency or less, for a predetermined time period or more, whether the heat load will become higher than that corresponding to the current point in time after the predetermined time period has elapsed using the heat load equation obtained by the heat load learning unit, and a signal generation unit that outputs, in a case where the estimation unit estimates that the heat load will not become higher, an oil return command signal commanding that an operating frequency be increased to the compressor, and that does not output, in a case where the estimation unit estimates that the heat load will become higher, the oil return command signal to the compressor.

An air-conditioning apparatus according to an embodiment of the present disclosure includes a controller including the heat load learning unit, the estimation unit, and the signal generation unit of the information processing apparatus, and a refrigerant circuit in which the compressor, a heat source side heat exchanger, an expansion device, and a load side heat exchanger are connected by refrigerant pipes, and in which refrigerant circulates.

An air-conditioning system according to an embodiment of the present disclosure includes an operation device provided with the heat load learning unit, the estimation unit, and the signal generation unit of the information processing apparatus, and a plurality of air-conditioning apparatuses communicatively connected to the operation device.

### Advantageous Effects of Invention

According to an embodiment of the present disclosure, a heat load corresponding to a time at which a predetermined time period has elapsed is estimated using a heat load equation obtained by using learning data concerning a heat load influencing factor. In a case where it is estimated that the heat load will not become higher, the compressor is commanded to perform the oil return operation; however, in a case where it is estimated that the heat load will become higher even when the low load operation of the compressor continues for a long time period, the compressor does not perform the oil return operation. This thus helps to prevent the oil return operation from being performed unnecessarily, As a result, the power consumption of the compressor is suppressed, and refrigerating machine oil can be efficiently collected.

### BRIEF DESCRIPTION OF DRAWINGS

FIG. 1 is a refrigerant circuit diagram illustrating an example of the configuration of an air-conditioning apparatus according to Embodiment 1 of the present disclosure.

FIG. 2 is a functional block diagram illustrating an example of the configuration of a controller illustrated in FIG. 1.

FIG. 3 is a schematic diagram for describing machine learning performed by a heat load learning unit, which is illustrated in FIG. 2.

FIG. 4 is a flow chart illustrating an example of the operation procedure of the heat load learning unit illustrated in FIG. 2.

FIG. 5 is a flow chart illustrating the operation procedure of the air-conditioning apparatus according to Embodiment 1 of the present disclosure.

FIG. 6 is a diagram illustrating another example of the configuration of the air-conditioning apparatus according to Embodiment 1 of the present disclosure.

FIG. 7 is a functional block diagram illustrating an example of the configuration of the air-conditioning apparatus and that of an information processing apparatus illustrated in FIG. 6.

FIG. 8 is a block diagram illustrating an example of the configuration of an air-conditioning system according to Embodiment 2 of the present disclosure.

### DESCRIPTION OF EMBODIMENTS

### Embodiment 1.

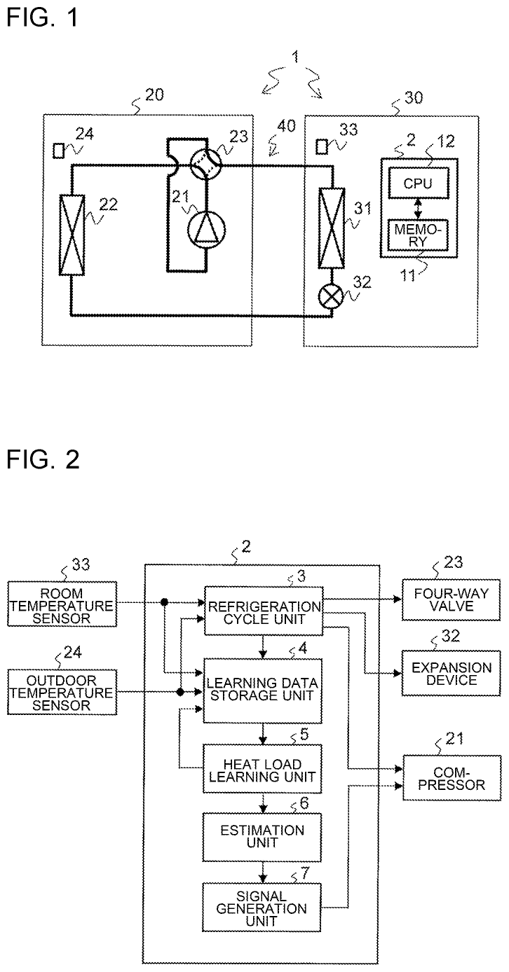

The configuration of an air-conditioning apparatus according to Embodiment 1 will be described. FIG. 1 is a refrigerant circuit diagram illustrating an example of the configuration of the air-conditioning apparatus according to Embodiment 1 of the present disclosure. An air-conditioning apparatus 1 has a heat source side unit 20 and a load side unit 30. The heat source side unit 20 has a compressor 21, a heat source side heat exchanger 22, and a four-way valve 23. The compressor 21 compresses and then discharges refrigerant. The heat source side heat exchanger 22 exchanges heat between outside air and refrigerant. The four-way valve 23 switches the direction in which refrigerant flows in accordance with an operation mode. The load side unit 30 has a load side heat exchanger 31, an expansion device 32, and a controller 2. The load side heat exchanger 31 exchanges heat between air in a room, which is an air-conditioning target space of the load side unit 30, and refrigerant. The expansion device 32 expands high-pressure refrigerant through decompression.

In Embodiment 1, a case is described in which the air-conditioning apparatus 1 cools and heats air in an indoor space by controlling a refrigeration cycle to keep the temperature of air in the indoor space constant; however, a configuration that performs one or both of air cooling and heating may be additionally provided. For example, the air-conditioning apparatus 1 may additionally have an electric heater as a configuration to heat air in the indoor space.

The compressor 21 is, for example, an inverter compressor that can change its capacity by changing its operating frequency. The expansion device 32 is, for example, an electronic expansion valve. The heat source side heat exchanger 22 and the load side heat exchanger 31 are, for example, a fin-and-tube heat exchanger. The compressor 21, the heat source side heat exchanger 22, the expansion device 32, and the load side heat exchanger 31 are connected by refrigerant pipes to form a refrigerant circuit 40, through which refrigerant circulates. The heat source side unit 20 is provided with an outdoor temperature sensor 24, which is configured to detect an outdoor temperature Tout. The load side unit 30 is provided with a room temperature sensor 33, which is configured to detect a room temperature Tr.

The configuration of the controller 2 illustrated in FIG. 1 will be described. The controller 2 is, for example, a microcomputer. As illustrated in FIG. 1, the controller 2 has a memory 11 and a central processing unit (CPU) 12. The memory 11 stores a program, and the CPU 12 execute processing in accordance with the program. The memory 11 is, for example, a nonvolatile memory such as a flash memory. The controller 2 is connected to the room temperature sensor 33, the outdoor temperature sensor 24, the four-way valve 23, the expansion device 32, and the compressor 21 through signal lines that are not illustrated in the drawing. A set temperature Tset for air in the room, which is an air-conditioning target space, is input to the controller 2 through a remote controller, which is not illustrated in the drawing. The memory 11 stores the set temperature Tset. The controller 2 has a timer, which is not illustrated in the drawing.

FIG. 2 is a functional block diagram illustrating an example of the configuration of the controller illustrated in FIG. 1, As illustrated in FIG. 2, the controller 2 has a refrigeration cycle unit 3, a learning data storage unit 4, a heat load learning unit 5, an estimation unit 6, and a signal generation unit 7. The learning data storage unit 4 is provided in the memory 11. The refrigeration cycle unit 3, the heat load learning unit 5, the estimation unit 6, and the signal generation unit 7 are configured in the controller 2 by the CPU 12 executing the program.

The refrigeration cycle unit 3 controls a refrigeration cycle of the refrigerant circuit 40 such that the room temperature Tr becomes the set temperature Tset. Specifically, the refrigeration cycle unit 3 controls the operating frequency of the compressor 21 and the opening degree of the expansion device 32 such that the room temperature Tr is maintained at the set temperature Tset.

The learning data storage unit 4 stores learning data for the heat load learning unit 5 to obtain a learning model through machine learning, the learning model being used to estimate a heat load that the air-conditioning apparatus 1 will take in the near future. The learning data is data concerning heat load influencing factors. In a case where the operation mode of the air-conditioning apparatus 1 is a cooling operation, the heat load corresponds to a cooling load. In a case where the operation mode of the air-conditioning apparatus 1 is a heating operation, the heat load corresponds to a heating load. The learning data storage unit 4 stores, as the learning data, a plurality of pieces of training data. In supervised learning, the plurality of pieces of training data serve as combined data composed of input data and output data.

The plurality of pieces of training data are stored in the learning data storage unit 4, and the timing of storage may be in the process of producing the air-conditioning apparatus 1 or after installation of the air-conditioning apparatus 1. The plurality of pieces of training data are combined data composed of air-conditioning data and heat load data, the combined data being chronologically collected in a case where, for example, the air-conditioning apparatus 1 has operated for one year. The air-conditioning data is data including, for example, the set temperature Tset, the room temperature Tr, the outdoor temperature Tout, and an operating frequency Fc of the compressor 21, It is desirable that the plurality of pieces of training data stored in the air-conditioning apparatus 1 differ from region to region including the place where the air-conditioning apparatus 1 is installed. This is because when the climate of a low-latitude region near the equator is compared with that of a high-latitude region away from the equator, annual changes in the outdoor temperature Tout greatly differ.

Moreover, the learning data storage unit 4 may chronologically collect air-conditioning data from the air-conditioning apparatus 1 and store the air-conditioning data as the learning data. In this case, the air-conditioning data is not data that is prepared but data that is actually collected from the air-conditioning apparatus 1, and thus serves as input data for unsupervised learning. If there is heat load data as output data corresponding to input data, the combination of the input data and the output data in this case serves as learning data for reinforcement learning.

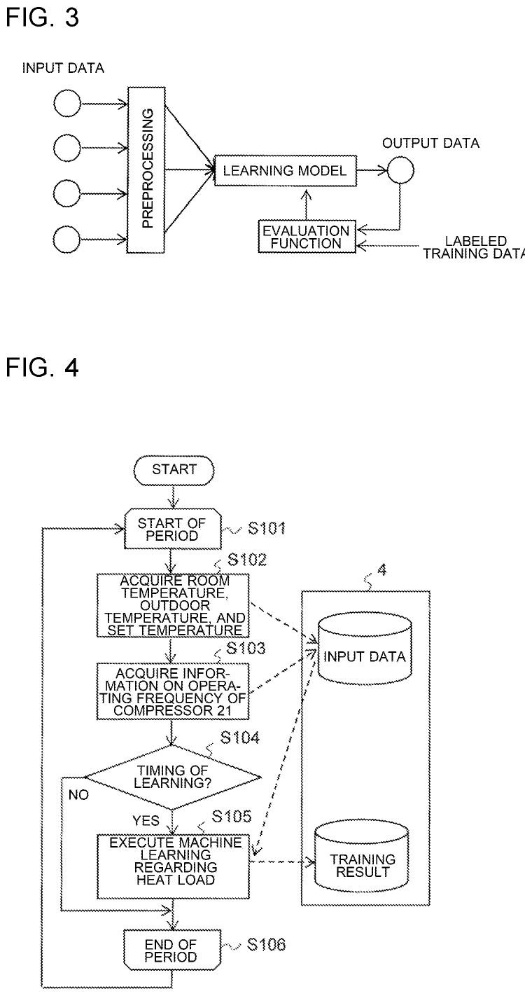

The heat load learning unit 5 obtains a heat load equation for calculating a heat load corresponding to a time at which a predetermined time period has elapsed from the current point in time by performing machine learning using the learning data stored in the learning data storage unit 4. An example of the machine learning performed by the heat load learning unit 5 will be described with reference to FIG. 3. FIG. 3 is a schematic diagram for describing the machine learning performed by the heat load learning unit illustrated in FIG. 2.

Input data are, for example, the room temperature Tr, the outdoor temperature Tout, the set temperature Tset, and the operation capacity of the compressor 21. In Embodiment 1, the operation capacity of the compressor 21 corresponds to the operating frequency Fc. The heat load learning unit 5 performs, as preprocessing, optimization of the input data and reduction of input dimensions to prevent overtraining. As an example of optimization processing for the input data, there is normalization processing. As another example of the optimization processing for the input data, when a temperature difference between the set temperature Tset and the room temperature Tr is denoted by ΔT, there is processing for calculating ΔT=Tset−Tr. In this case, the number of temperature parameters is reduced by one, and thus the calculation load for the heat load learning unit 5 is reduced. Note that in a case where a temperature sensor (not illustrated) configured to detect a temperature Tc of air issuing from the load side unit 30 is provided in the load side unit 30, the temperature difference ΔT may be ΔT=Tc Tset. The preprocessing is inessential processing in the machine learning.

The heat load learning unit 5 substitutes input data subjected to the preprocessing into the heat load equation, which is the learning model, and calculates an estimated heat load Qp, which is a future heat load. The heat load equation is used to relatively calculate the estimated heat load Qp corresponding to a time at which a predetermined time period has elapsed from the current point in time with respect to an actual heat load Qr, which is a heat load based on actually measured air-conditioning data. The heat load learning unit 5 compares the actual heat load Qr serving as labeled training data with the estimated heat load Qp, which will be output data, and evaluates the validity of the heat load equation using an evaluation function. The heat load learning unit 5 then updates the heat load equation such that the output data calculated from the heat load equation approaches the labeled training data.

As a specific example of the heat load equation, a case will be described in which an estimated heat load Qp corresponding to a time at which a predetermined time period t has elapsed from the current point in time is estimated. The predetermined time period t is, for example, ten minutes. An example of the equation for the estimated heat load Qp in a case where the room temperature Tr, the outdoor temperature Tout, the set temperature Tset, and the operating frequency Fc of the compressor 21 are input data is expressed by Eq. (1).

### [Math 1]

QP(tk)=f(Tr, Tout, Tsey, Fc, . . . , tk (1)

In Eq. (1), when k is an integer greater than or equal to one, tk denotes a time in units of a period Tk. Eq. (1) indicates that an expression f for calculating the estimated heat load Qp includes five parameters, which are the room temperature Tr, the outdoor temperature Tout, the set temperature Tset, the operating frequency Fc of the compressor 21, and the time tk. Eq. (1) indicates a case where there are four heat load influencing factors, which are the room temperature Tr, the outdoor temperature Tout, the set temperature Tset, and the operating frequency Fc of the compressor 21; however, the number of influencing factors is not limited to four. The heat load influencing factors may include, for example, heat transfer loads and heat transfer loss loads from respective walls and windows of the building in which the air-conditioning apparatus 1 is installed. Furthermore, an example obtained by concretizing Eq. (1) will be expressed by Eq. (2).

$$\begin{matrix} [ Math 2 ] & \\ Qp ( tk ) = w 1 \cdot \frac{( {Tr}_{( tk - 2 )} - {Tr}_{( tk - 1 )} )}{( tk - 1 - tk - 2 )} \cdot tk + w 2 \cdot \frac{( {Tout}_{( tk - 1 )} - {Tout}_{( tk - 2 )} )}{( tk - 1 - tk - 2 )} \cdot tk - w 3 \cdot \frac{( {Fc}_{( tk - 1 )} - {Fc}_{( tk - 2 )} )}{( tk - 1 - tk - 2 )} \cdot tk + α & ( 2 )\end{matrix}$$

In Eq. (2), w1 to w3 denote weighting factors, and a denotes a correction value uniquely corresponding to the air-conditioning apparatus 1. For each of the weighting factors w1 to w3 and the correction value a, a standard value is prestored in the memory 11. The numerator of the first term of the right side of Eq. (2) is calculated from an expression that is (Tset−Tr₍ₜₖ₋₁₎) −(Tset−Tr₍ₜₖ₋₂₎). Eq. (2) indicates a case where there are four heat load influencing factors; however, the number of influencing factors is not limited to four. For each of the weighting factors w1 to w3, the correction value α, and a correction value β, a standard value is prestored in the memory 11; however, the weighting factors w1 to w3 and the correction values α and β will be updated to values corresponding to the air-conditioning apparatus 1 through the machine learning performed by the heat load learning unit 5.

The memory 11 may store an actual heat load equation, which is a heat load equation for calculating the actual heat load Qr, which serves as the labeled training data. An example of the actual heat load equation for calculating the actual heat load Qr, which is approximated to a real heat load, is expressed by Eq. (3). In Eq. (3), U and V denote correction coefficients uniquely corresponding to the air-conditioning apparatus 1, and β denotes a correction value uniquely corresponding to the air-conditioning apparatus 1. U, V, and β are set to correspond to the environment including the building in which the air-conditioning apparatus 1 is installed and the climate. U, V, and β are stored in the memory 11 when the air-conditioning apparatus 1 is installed.

### [Math 3]

Qr(tk)=U·(Tset−Tr₍ₜₖ₎)+V·Tout₍ₜₖ₎+β (3)

In this case, the heat load learning unit 5 calculates an estimated heat load Qp(tk) using Eq. (2) and causes the learning data storage unit 4 to store the calculated estimated heat load Qp(tk). Subsequently, after the predetermined time period t has elapsed, the heat load learning unit 5 calculates an actual heat load Qr(tk) using Eq. (3). The heat load learning unit 5 then evaluates the validity of Eq. (2) by comparing the estimated heat load Qp(tk) with the actual heat load Qr(tk) and updates Eq. (2) such that the value of the estimated heat load Qp(tk) approaches that of the actual heat load Qr(tk). Note that, in Embodiment 1, the case has been described in which Eq. (2) for calculating the estimated heat load Qp, which is a future heat load, differs from Eq. (3) for calculating the actual heat load Qr, which is a heat load approximated to the real heat load; however, these equations may be expressed by one equation.

FIG. 4 is a flow chart illustrating an example of the operation procedure of the heat load learning unit illustrated in FIG. 2. Here, a case will be described in which machine learning corresponds to reinforcement learning using Eqs. (2) and (3). The heat load learning unit 5 performs processing in steps S101 to S106 illustrated in FIG. 4 on a period Tk basis, When m is an integer greater than or equal to two, the learning data storage unit 4 stores air-conditioning data collected in respective periods T1 to Tm−1 up to the period Tm−1. Moreover, the learning data storage unit 4 stores estimated heat loads Qp(t2) to Qp(tm) estimated by the heat load learning unit 5 and actual heat loads Qr(t1) to Qr(tm−1) calculated by the heat load learning unit 5.

In a period Tm (step S101), the heat load learning unit 5 stores, in the learning data storage unit 4, the room temperature Tr detected by the room temperature sensor 33, the outdoor temperature Tout detected by the outdoor temperature sensor 24, and the set temperature Tset (step S102), Subsequently, the heat load learning unit 5 acquires information on the operating frequency of the compressor 21 from the refrigeration cycle unit 3 and stores the information in the learning data storage unit 4 (step S103).

The heat load learning unit 5 determines whether it is the timing of machine learning (step S104). For example, immediately after the start-up of the air-conditioning apparatus 1 or the like, there may be a case where the value of acquired air-conditioning data is unstable and the error between the heat load estimated from the air-conditioning data and a real heat load is large. In addition, when the period Tk is too short relative to the computing speed of the CPU 12, there may be a case where the calculation processing for the heat load learning unit 5 falls behind. If machine learning is executed in cases like these, the learning model may be updated in a wrong direction. Thus, the heat load learning unit 5 changes the length of a learning period as appropriate in accordance with, for example, the operation state of the air-conditioning apparatus 1 and the processing performance of the CPU 12 and the memory 11, The length of the learning period may be set by the user.

When it is determined in step S104 by the heat load learning unit 5 that it is not the timing of machine learning, the process ends (step S106) and returns to step S101, and the heat load learning unit 5 is put on standby until the next period Tm+1. In contrast, when it is determined in step S104 by the heat load learning unit 5 that it is the timing of machine learning, the heat load learning unit 5 calculates an estimated heat load Qp(tm+1) corresponding to the period Tm+1 using the acquired air-conditioning data and Eq. (2). Moreover, the heat load learning unit 5 calculates an actual heat load Qr(tm) corresponding to the period Tm using the acquired air-conditioning data and Eq. (3). The heat load learning unit 5 stores, in the learning data storage unit 4, the calculated estimated heat load Qp(tm+1) and the calculated actual heat load Qr(tm).

The heat load learning unit 5 compares the calculated actual heat load Qr(tm) with the estimated heat load Qp(tm) stored in the learning data storage unit 4 and adjusts the weighting factors w1 to w3 and the correction value α of Eq. (2) such that the estimated heat load Qp(tm) matches the actual heat load Qr(trn). The heat load learning unit 5 updates Eq. (3) stored in the learning data storage unit 4 to Eq. (3) having the adjusted weighting factors w1 to w3 and the adjusted correction value a (step S105).

By repeating the procedure illustrated in FIG. 4, the heat load equation is updated to correspond to the configuration and the latest operation state of the air-conditioning apparatus 1. In Embodiment 1, the case has been described in which the heat load learning unit 5 uses machine learning as a method for obtaining a learning model; however, deep learning may be used or a neural network may be used depending on the desired heat load accuracy and the computational performance of the CPU 12. For example, in the case of deep learning, the heat load learning unit 5 performs processing for extracting a feature parameter that greatly affects the heat load in Eq. (2) and updates Eq. (2) such that the weight of the extracted parameter is increased.

Subsequently, the configuration of the estimation unit 6 and the signal generation unit 7 illustrated in FIG. 2 will be described. The estimation unit 6 illustrated in FIG. 2 estimates a future operation state of the air-conditioning apparatus 1 using the heat load equation trained by the heat load learning unit 5 and determines whether to perform an oil return operation. Specifically, in a case where the air-conditioning apparatus 1 continues performing a low load operation for a predetermined threshold time period Tth or more, the estimation unit 6 estimates, using the heat load equation obtained by the heat load learning unit 5, whether the heat load will increase after the predetermined time period t has elapsed. The low load operation corresponds to a case where, for example, the compressor 21 operates at the operating frequency Fc less than or equal to a predetermined standard operating frequency F0. The memory 11 stores the threshold time period Tth and the standard operating frequency F0. The oil return operation is an operation in which the flow speed of refrigerant flowing in the refrigerant circuit 40 is increased by operating the compressor 21 at the operating frequency Fc higher than the standard operating frequency F0 to collect refrigerating machine oil from the refrigerant circuit 40 into the compressor 21.

The signal generation unit 7 determines whether to output a signal to an external device depending on whether the heat load estimated by the estimation unit 6 and corresponding to a time at which the predetermined time period t has elapsed will increase. Specifically, in a case where the estimation unit 6 estimates that the heat load will not increase after the predetermined time period t has elapsed, the signal generation unit 7 outputs, to the compressor 21, an oil return command signal commanding that the operating frequency be increased. In a case where the estimation unit 6 estimates that the heat load will increase after the predetermined time period t has elapsed, the signal generation unit 7 does not output the oil return command signal to the compressor 21.

With a configuration in which the air-conditioning apparatus 1 has an electric heater, which is not illustrated, the signal generation unit 7 may output the oil return command signal to the compressor 21 and also send a start-up command signal to the electric heater in a case where the cooling operation is being performed. In this case, air in the indoor space is further cooled by increasing the operating frequency Fc of the compressor 21; however, the state of the electric heater is switched from OFF to ON, and thus the indoor space can be prevented from being overcooled.

Note that FIG. 1 illustrates a configuration corresponding to the case where the controller 2 is provided in the load side unit 30; however, the installation position of the controller 2 is not limited to the load side unit 30. The controller 2 may be provided in the heat source side unit 20 instead of the load side unit 30. In Embodiment 1, the case has been described in which the controller 2 communicates with a plurality of sensors and a plurality of refrigerant devices in a wired manner; however, the controller 2 may communicate with the plurality of sensors and the plurality of refrigerant devices in a wireless manner. Moreover, in Embodiment 1, the case has been described in which the outdoor temperature sensor 24 configured to detect the outdoor temperature Tout is provided in the air-conditioning apparatus 1; however, the way in which the outdoor temperature Tout is acquired is not limited to that of this case. For example, in a case where the controller 2 is connected to a network such as the Internet, information on the outdoor temperature Tout may be acquired through the network from a Web server that provides weather forecast information.

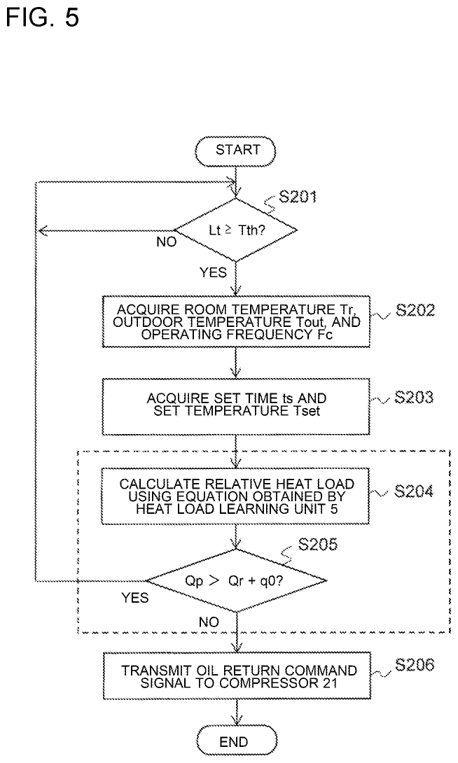

Next, the operation procedure of the air-conditioning apparatus 1 of Embodiment 1 will be described. FIG. 5 is a flow chart illustrating the operation procedure of the air-conditioning apparatus according to Embodiment 1 of the present disclosure. Steps S201 to S206 illustrated in FIG. 5 are performed in a predetermined period. The predetermined period is, for example, ten minutes. A set time ts is a time corresponding to a heat load estimated with respect to the current time. In Embodiment 1, the set time ts is a time at which the predetermined time period t has elapsed from the current time. The set time ts may be set by the user. The set temperature Tset is a temperature set by the user through the remote controller, which is not illustrated, A broken line frame illustrated in FIG. 5 indicates processing performed by the estimation unit 6 on the basis of the heat load equation obtained by the heat load learning unit 5. The set time ts and the set temperature Tset are stored by the learning data storage unit 4.

When the compressor 21 operates at the operating frequency Fc less than or equal to the standard operating frequency F0, the estimation unit 6 is notified of that compressor 21 by the refrigeration cycle unit 3. The estimation unit 6 measures a time period Lt in which the compressor 21 operates at operating frequencies less than or equal to the standard operating frequency F0 and determines whether the measured time period Lt is greater than or equal to the threshold time period Tth (step S201). In a case where the time period Lt is less than the threshold time period Tth, the estimation unit 6 monitors a notification from the refrigeration cycle unit 3.

As a result of the determination in step S201, in a case where the time period Lt is greater than or equal to the threshold time period Tht, the estimation unit 6 acquires the current room temperature Tr and the current outdoor temperature Tout from the room temperature sensor 33 and the outdoor temperature sensor 24. The estimation unit 6 acquires the operating frequency Fc of the compressor 21 from the refrigeration cycle unit 3 (step S202). Subsequently, the estimation unit 6 acquires the set time ts and the set temperature Tset from the learning data storage unit 4 (step S203). The estimation unit 6 then calculates the current actual heat load Qr using the heat load equation obtained by the heat load learning unit 5. The estimation unit 6 calculates a relative estimated heat load Qp corresponding to the set time ts with respect to the current point in time using the heat load equation obtained by the heat load learning unit 5 (step S204). Note that, instead of calculating the current actual heat load Qr, the estimation unit 6 may read out, from the learning data storage unit 4, the latest actual heat load Qr among a plurality of actual heat loads Qr calculated by the heat load learning unit 5.

Subsequently, the estimation unit 6 determines whether the heat load will become higher at the set time ts than at the current time. A method to determine whether the heat load is relatively high is, for example, a method to determine whether the estimated heat load Qp is higher than the actual heat load Qr by a set determination correction value q0 or more. The determination correction value q0 is stored in the learning data storage unit 4. The estimation unit 6 determines whether the estimated heat load Qp corresponding to the set time ts is higher than the current actual heat load Qr by the determination correction value q0 or more (step S205). The determination correction value q0 may be q0=0.

As a result of the determination in step S205, in a case where the estimated heat load Qp in the future is higher than the current actual heat load Qr, the estimation unit 6 estimates that the operating frequency Fc of the compressor 21 will become higher than the standard operating frequency F0 in the near future. It is conceivable that the operating frequency Fc of the compressor 21 will increase and the air-conditioning apparatus 1 will shift to a high load operation in the near future. In this case, the signal generation unit 7 determines that refrigerating machine oil will be collected from the refrigerant circuit 40 without commanding the compressor 21 to perform the oil return operation. As a result, the signal generation unit 7 does not send the oil return command signal to the compressor 21. For the estimation unit 6, the process returns to step S201.

In contrast, as a result of the determination in step S205, in a case where the7 estimated heat load Qp in the future is not higher than the current actual heat load Qr, the estimation unit 6 estimates that the operating frequency Fc of the compressor 21 will be maintained in a state in which the operating frequency Fc is less than or equal to the standard operating frequency F0 even at the set time ts. In this case, the signal generation unit 7 determines that refrigerating machine oil should be collected from the refrigerant circuit 40 by increasing the operating frequency Fc of the compressor 21.

As a result, the signal generation unit 7 sends the oil return command signal to the compressor 21 (step S206).

In a state in which the air-conditioning apparatus 1 performs the high load operation, the operating frequency Fc of the compressor 21 is high, and thus a sufficient amount of refrigerating machine oil is collected into the compressor 21. Thus, there is no need to additionally cause the compressor 21 to perform the oil return operation. In a case where the air-conditioning apparatus 1 has performed the low load operation for a long time period, the oil return operation needs to be performed; however, if it can be estimated that the air-conditioning apparatus 1 will shift to the high load operation in the near future, the oil return operation does not need to be performed. According to the procedure illustrated in FIG. 5, even in a case where the air-conditioning apparatus 1 has performed the low load operation for a long time period, when the estimation unit 6 estimates that the air-conditioning apparatus 1 will shift to the high load operation in the near future, the compressor 21 is not caused to perform the oil return operation. In this case, even without being commanded to perform the oil return operation, the compressor 21 will shift from the low load operation to the high load operation when the heat load becomes high, and thus refrigerating machine oil is collected from the refrigerant circuit 40 into the compressor 21.

With reference to FIGS. 1 to 5, the case has been described in which the air-conditioning apparatus 1 includes a configuration that performs oil return control, the configuration including the learning data storage unit 4, the heat load learning unit 5, the estimation unit 6, and the signal generation unit 7; however, the configuration that performs oil return control may be provided separately from the air-conditioning apparatus 1.

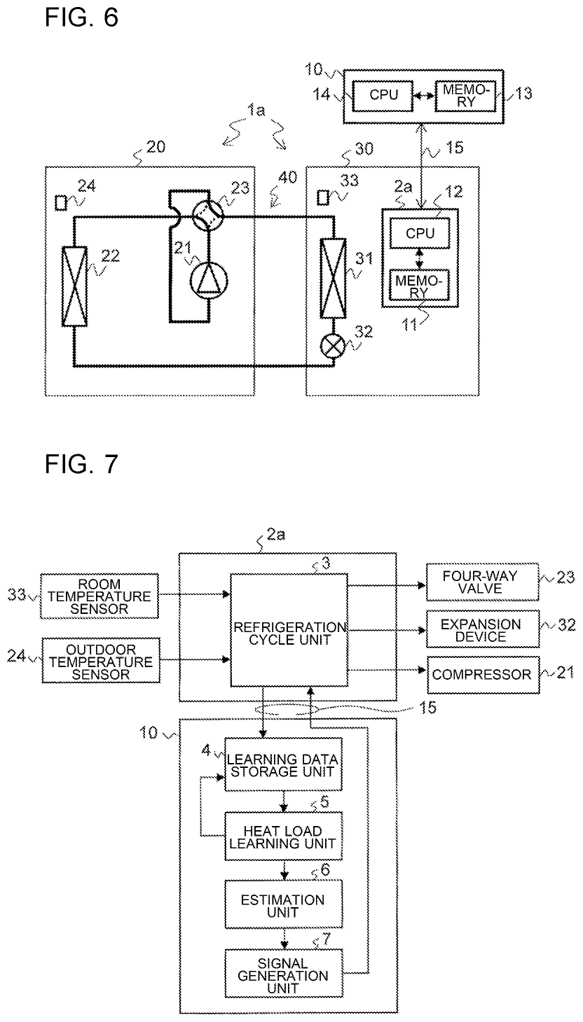

FIG. 6 is a diagram illustrating another example of the configuration of the air-conditioning apparatus according to Embodiment 1 of the present disclosure. FIG. 7 is a functional block diagram illustrating an example of the configuration of the air-conditioning apparatus and that of an information processing apparatus illustrated in FIG. 6. As illustrated in FIG. 6, a controller 2a of an air-conditioning apparatus 1a is connected to an information processing apparatus 10 via a signal line 15. The information processing apparatus 10 has a memory 13 and a CPU 14. The memory 13 stores a program, and the CPU 14 executes processing in accordance with the program. The signal line 15 may be a network such as the Internet.

As illustrated in FIG. 7, the information processing apparatus 10 has the learning data storage unit 4, the heat load learning unit 5, the estimation unit 6, and the signal generation unit 7, The learning data storage unit 4 is provided in the memory 13. The heat load learning unit 5, the estimation unit 6, and the signal generation unit 7 are configured in the information processing apparatus 10 by the CPU 14 executing processing in accordance with the program. The controller 2a has the refrigeration cycle unit 3. The refrigeration cycle unit 3 is configured in the controller 2a by the CPU 12 executing processing in accordance with the program.

The operation of the information processing apparatus 10 described with reference to FIGS. 6 and 7 is substantially the same as the operation described with reference to FIGS. 4 and 5, and thus detailed description thereof will be omitted. As illustrated in FIGS. 6 and 7, even when the air-conditioning apparatus la is not provided with the learning data storage unit 4, the heat load learning unit 5, the estimation unit 6, and the signal generation unit 7, the oil return control described with reference to FIGS. 1 to 5 can be performed.

In the configuration illustrated in FIGS. 6 and 7, the memory 11 of the controller 2a may store air-conditioning data collected chronologically. In this case, when the heat load learning unit 5 and the estimation unit 6 calculate a heat load, it is sufficient that the information processing apparatus 10 acquire air-conditioning data from the controller 2a via the signal line 15. Furthermore, a storage device for storing learning data may be provided in addition to the memories 11 and 13. The storage device is, for example, a hard disk drive (HDO) device.

The information processing apparatus 10 of Embodiment 1 has the heat load learning unit 5, the estimation unit 6, and the signal generation unit 7. The heat load learning unit 5 obtains a heat load equation for calculating a heat load corresponding to a time at which the predetermined time period t has elapsed from the current point in time using learning data concerning the heat load influencing factors of the air-conditioning apparatus 1. In a case where the compressor 21 continues performing the low load operation, in which operation is performed at the standard operating frequency F0 or less, for the threshold time period Tht or more, the estimation unit 6 estimates whether the heat load will become higher than that of the current point in time after the predetermined time period t has elapsed using the heat load equation obtained by the heat load learning unit 5. In a case where the estimation unit 6 estimates that the heat load will not become higher, the signal generation unit 7 outputs the oil return command signal to the compressor 21. In a case where the estimation unit 6 estimates that the heat load will become higher, the signal generation unit 7 does not output the oil return command signal to the compressor 21.

The air-conditioning apparatus 1 of Embodiment 1 has the controller 2 and the refrigerant circuit 40. The controller 2 includes the heat load learning unit 5, the estimation unit 6, and the signal generation unit 7. The refrigerant circuit 40 includes the compressor 21.

According to Embodiment 1, a heat load corresponding to a time at which the predetermined time period t has elapsed is estimated using the heat load equation obtained using the learning data concerning the heat load influencing factors. In a case where it is estimated that the heat load will become higher, the compressor 21 is not commanded to perform the oil return operation. In a case where it is estimated that the heat load will not become higher, the compressor 21 is commanded to perform the oil return operation. Even when the low load operation of the compressor 21 continues for a long time period, the compressor 21 does not perform the oil return operation in a case where it is estimated that the heat load will become higher, which helps to prevent the oil return operation from being performed unnecessarily. When the heat load becomes high, the operating frequency Fc of the compressor 21 is increased, so that the flow rate of refrigerant flowing in the refrigerant circuit 40 is adequately ensured, and refrigerating machine oil is collected into the compressor 21, As a result, the power consumption of the compressor 21 is suppressed, and refrigerating machine oil can be efficiently collected.

Hitherto, after operating in a low heat load state for a long time period, an air-conditioning apparatus needs to perform an oil return operation for returning refrigerating machine oil into a compressor. However, in a case where it is estimated that the heat load will increase after a predetermined time period, for example, a few minutes, the air-conditioning apparatus 1 of Embodiment 1 does not cause the compressor 21 to perform the oil return operation. Even when the compressor 21 is not caused to perform the oil return operation, the air-conditioning apparatus 1 can reduce the heat load and collect refrigerating machine oil at the same time if the compressor 21 performs an operation for reducing the heat load in accordance with an increase in heat load. Thus, the oil return operation can be prevented from being performed unnecessarily.

In Embodiment 1, the learning data may be a plurality of pieces of labeled training data. Ina case where the plurality of pieces of training data differ from region to region including the place where the air-conditioning apparatus 1 is installed, the plurality of pieces of training data are data matching the climate of the region where the air-conditioning apparatus 1 is installed, and the heat load calculated using the heat load equation obtained by the heat load learning unit 5 is close to the real heat load of the air-conditioning apparatus 1.

In Embodiment 1, the learning data may be air-conditioning data collected from the air-conditioning apparatus 1. In this case, a heat load is estimated on the basis of the air-conditioning data acquired from the environment where the air-conditioning apparatus 1 is actually used, and thus the accuracy of heat load estimation improves. As a result, the oil return operation can further be prevented from being performed unnecessarily. Moreover, the heat load learning unit 5 may determine whether the heat load equation is valid using air-conditioning data collected from the air-conditioning apparatus 1 and update the heat load equation in accordance with the determination result. In this case, the accuracy of estimation of a heat load calculated using the heat load equation can further be improved.

Note that in a case where the compressor 21 performs the oil return operation regardless of the temperature difference between the room temperature Tr and the set temperature Tset, the room temperature Tr may become separated from the set temperature Tset because the operating frequency Fc increases. In contrast to this, in a case where the air-conditioning apparatus 1 is provided with an electric heater, which is not illustrated, and is performing the cooling operation, the electric heater may be started up when the oil return command signal is output to the compressor 21. Although air in the indoor space is further cooled by increasing the operating frequency Fc of the compressor 21, the indoor space can be prevented from being overcooled by switching the state of the electric heater from OFF to ON. As a result, changes in the room temperature Tr are suppressed, and the room temperature Tr can be stabilized,

### Embodiment 2.

In Embodiment 2, the information processing apparatus described in Embodiment 1 is communicatively connected to a plurality of air-conditioning apparatuses. In Embodiment 2, configurations substantially the same as those described in Embodiment 1 will be denoted by the same reference numerals, and detailed description thereof will be omitted.

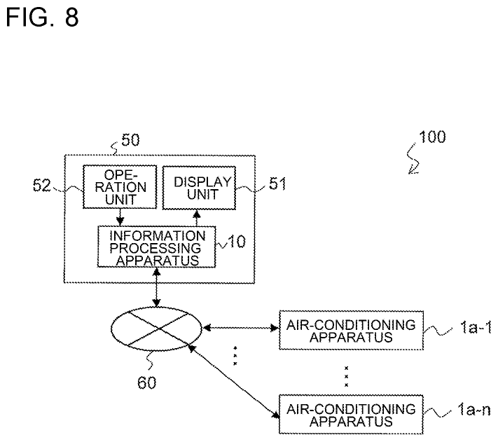

The configuration of an air-conditioning system of Embodiment 2 will be described. FIG. 8 is a block diagram illustrating an example of the configuration of the air-conditioning system according to Embodiment 2 of the present disclosure. As illustrated in FIG. 8, an air-conditioning system 100 has a plurality of air-conditioning apparatuses 1a-1 to 1a-n and an operation device 50, which is communicatively connected to the plurality of air-conditioning apparatuses 1a-1 to 1a-n via a network 60, where n is a positive integer greater than or equal to two. The network 60 may be something else. Communication connection means between the plurality of air-conditioning apparatuses 1a-1 to 1a-n and the operation device 50 may be one out of or both of wired means and wireless means. The operation device 50 is, for example, installed in a maintenance company that maintains the plurality of air-conditioning apparatuses 1a-1 to 1a-n. The operation device 50 may be installed in a control office of the company in which the plurality of air-conditioning apparatuses 1a-1 to 1a-n are installed.

The operation device 50 has the information processing apparatus 10, which is described with reference to FIGS. 6 and 7, a display unit 51, and an operation unit 52. The operation unit 52 is used by a worker belonging to the maintenance company to input a command to the information processing apparatus 10. The operation device 50 collects air-conditioning data from each of the plurality of air-conditioning apparatuses 1a-1 to 1a-n. For each of the plurality of air-conditioning apparatuses 1a-1 to 1a-n, the information processing apparatus 10 performs the oil return control described in Embodiment 1, The display unit 51 displays information indicating, for example, the operation state of each of the plurality of air-conditioning apparatuses 1a-1 to 1a-n.

According to Embodiment 2, the function of the information processing apparatus 10 through which the oil return control is performed is provided not in the main bodies of the air-conditioning apparatuses but in the operation device 50. That is, the configuration that performs the oil return control and the air-conditioning apparatuses are separate products, the configuration including the learning data storage unit 4, the heat load learning unit 5, the estimation unit 6, and the signal generation unit 7. Thus, even in a model in which the air-conditioning apparatuses 1a-1 to 1a-n are not provided with a configuration that performs the oil return control, the oil return control described in Embodiment 1 can be applied to the air-conditioning apparatuses 1a-1 to 1a-n by enabling these apparatuses to communicate with the operation device 50. For example, even in a case where the air-conditioning apparatus 1a-1 is not provided with a configuration that performs the oil return control and has already been installed, it is sufficient that the air-conditioning apparatus 1a-1 be enabled to communicate with the operation device 50.

Moreover, in Embodiment 2, the operation device 50 may monitor the operation states of the plurality of air-conditioning apparatuses 1a-1 to 1a-n and perform control such that two or more out of the air-conditioning apparatuses do not simultaneously perform the oil return operation. This can prevent the power consumption of the building from temporarily increasing in a case where the plurality of air-conditioning apparatuses 1a-1 to 1a-n are installed in the same building.

Note that, in Embodiment 2, the case has been described in which the operation device 50 has the display unit 51 and the operation unit 52; however, the operation device 50 does not necessarily have the display unit 51 and the operation unit 52.

### REFERENCE SIGNS LIST

1, 1a, 1a-1 to 1a-n: air-conditioning apparatus, 2, 2a: controller, 3: refrigeration cycle unit, 4: learning data storage unit, 5: heat load learning unit, 6: estimation unit, 7: signal generation unit, 10: information processing apparatus, 11; memory, 12: CPU, 13: memory, 14: CPU, 15: signal line, 20: heat source side unit, 21: compressor, 22: heat source side heat exchanger, 23: four-way valve, 24: outdoor temperature sensor, 30: load side unit, 31: load side heat exchanger, 32: expansion device, 33: room temperature sensor, 40: refrigerant circuit, 50: operation device, 51: display unit, 52:

operation unit, 60: network, 100: air-conditioning system.

1. An information processing apparatus comprising:
a memory storing a program,
a processor configured to execute a process according to the program, wherein the processor being configured to
obtain a heat load equation for calculating a heat load corresponding to a time at which a predetermined time period has elapsed from a current point in time using learning data concerning a heat load influencing factor of an air-conditioning apparatus including a compressor;
estimate, in a case where the compressor continues performing a low load operation, in which operation is performed at a standard operating frequency or less, for a predetermined time period or more, whether the heat load will become higher than that corresponding to the current point in time after the predetermined time period has elapsed using the heat load equation; and
output, in a case where the estimation unit estimates that the heat load will not become higher, an oil return command signal commanding that an operating frequency be increased to the compressor, and not output, in a case where the estimation unit estimates that the heat load will become higher, the oil return command signal to the compressor.

2. The information processing apparatus of claim 1, wherein the memory stores a plurality of pieces of training data as the learning data.

3. The information processing apparatus of claim 1, wherein the memory chronologically collects and stores air-conditioning data as the learning data, the air-conditioning data including a set temperature of an air-conditioning target space, a room temperature that is a temperature of a room in the air-conditioning target space, an outdoor temperature, and the operating frequency of the compressor.

4. The information processing apparatus of claim 3, wherein
the processor determines whether the heat load equation is valid using the air-conditioning data stored in the memory and updates the heat load equation in accordance with a determination result.

5. The information processing apparatus of claim 4, wherein
the processor calculates, based on the heat load equation, an estimated heat load that is a heat load corresponding to a time at which the predetermined time period has elapsed, calculates an actual heat load that is a real heat load using the air-conditioning data collected after the predetermined time period has elapsed, and updates the heat load equation such that the estimated heat load matches the actual heat load.

6. An air-conditioning apparatus comprising:
the information processing apparatus of claim 1; and
a refrigerant circuit in which the compressor, a heat source side heat exchanger, an expansion device, and a load side heat exchanger are connected by refrigerant pipes, and in which refrigerant circulates.

7. An air-conditioning system comprising:
an operation device provided with the information processing apparatus of claim 1, and
a plurality of air-conditioning apparatuses communicatively connected to the operation device.

8. The air-conditioning system of claim 7, wherein the operation device is communicatively connected to the plurality of air-conditioning apparatuses via a network.
